(19) United States
(12) Patent Application Publication
(10) Pub. No.: US 2001/0023911 A1
(43) Pub. Date: Sep. 27, 2001

(54) Stackable clamp for cables or pipes

(75) Inventor: Gerardus Johannes Antonius Wilhelmus Kommers, Goes (NL)

Correspondence Address: YOUNG & THOMPSON, 745 SOUTH 23RD STREET 2ND FLOOR, ARLINGTON, VA, 22202

(73) Assignee: KOZ Products B.V.

(21) Appl. No.: 09/813,961

(22) Filed: Mar. 22, 2001

(30) Foreign Application Priority Data
Mar. 22, 2000 (NL) 1014724

(51) Int. Cl. F16L 3/08

(52) U.S. Cl. 248/74.1; 248/74.4

(57) ABSTRACT

Clamp for a cable or pipe, comprising a bottom shell and a top shell, in which shells the sides facing each other are provided with a recess for accommodating at least one cable or one pipe. The underside of the bottom shell provides for a flat support surface, and Me top shell has a substantially outward cured top surface. The top side of the top shell is provided with a flat supporting surface, which runs parallel to the support surface of the bottom shell.

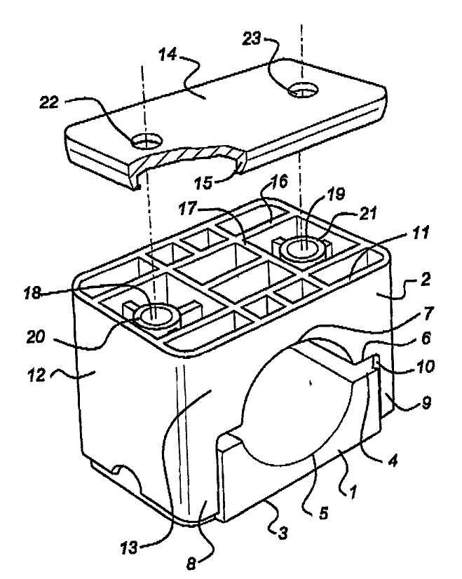

The invention relates to a clamp, for example for cables or pipes, comprising a bottom shell and a top shell, in which shells the sides facing each other are provided with a recess for accommodating at least one cable or pipe, the underside of the bottom shell providing for a flat support surface, and the top shell having a substantially outward curved top surface.

Such clamps are already generally known. One of those clamps is suitable for one cable and is composed of a bottom and top shell that are provided with guide elements, by means of which said shells can be slid into and out of each other in only one plane. A cable accommodated in the recesses of the facing sides of the bottom and top shells is clamped by sliding the shells of the cable clamp into each other, pressing them against each other and fixing them in this position pressed together.

The object of the invention is to provide a clamp by means of which it is possible to male, the best possible use of the available space for cables or pipes This object is achieved according to the invention by the fact that the top side of the top shell is provided with a flat supporting surface that runs parallel to the support surface of the bottom shell.

Said flat supporting surface of the top shell is preferably formed by a raised ridge running around said shell, the distance of the end face of the ridge from die underside of the top shell being equal to or greater than the greatest distance of the curved top surface of the top shell from said underside.

This makes it possible to use a cover of a simple shape, in particular a substantially flat cover.

Embodiments of the clamp according to the invention and of the cover to be used for it are described in the subclaims.

The invention will be explained in greater detail below with reference to a preferred embodiment of a cable clamp according to the invention, which is shown in the appended drawing. The cable clamp shown is suitable for a cable, but it is pointed out that the invention is also applicable to a clamp for clamping more than one cable and, because of its strength, also for clamping pipes and the like.

As known, and as illustrated in the figure, the cable clamp is composed of a bottom shell 1 and a top shell 2. The underside of the bottom shell 1 is of a flat design, in order to support said bottom shell stably and securely on a base (not shown). The top side of the bottom shell 1 has a top surface 4, which is provided with a curved recess 5, the radius of curvature of which is equal to or slightly larger than the largest cable diameter for which tis cable clamp is dimensioned,

The top shell 2 of the cable clamp has a bottom surface 6, in which a recess 7 is provided, the radius of curvature of which recess corresponds to that of the recess 5 in the top surface 4 of the bottom shell 1.

In the embodiment shown, the top shell has two legs 8 and 9, which legs are provided with a guide groove 10, which extends in the upward direction, perpendicular to the bottom surface 6 of the top shell 2. A projecting guide element or guide rib (not visible in the drawing) fits in a slidable manner into said guide groove 10, Through interaction of the guide grooves 10 and projecting guide ribs, the bottom and top shells can be slid relative to each other in a plane perpendicular to the bottom surface 3 of the bottom shell 1 and the axes of the recesses 5 and 7 in the bottom shell 1 and top shell 2 respectively. This ability of the bottom shell 1 and top shell 2 to slide relative to each other means that cables of various diameters can be accommodated in the recesses 5 and 7 and clamped in by holding the bottom shell 1 and top shell 2 pressed together,

Top shells in which the top side has a substantially outward curved top surface whose radius of curvature is generally greater than that of the recess 7 in the bottom surface 6 of the top shell 2 have already been in use for many years. On the ends of the top shell following he curved top surface there are flat pieces in which holes are provided for screwing the top shell 2 onto the bottom shell 1.

The Applicant noticed that there was a need for the best possible utilization of the available space for cables to be laid. This can be achieved by placing the cables not only alongside each other, but also in layers above one another, and fixing them. In order to meet this need, according to the invention the top side of the top shell 2 is provided with a flat supporting surface that runs parallel to the support surface 3 of the bottom shell 1. This means that the cable clamps can be stacked stably and securely for the purpose of laying various cable layers one above the other.

In the cable clamp according to the invention illustrated in the figure the supporting surface of the top shell 2 is formed by a raised ridge 11 running around said shell, The distance of the end face of the ridge 11 from the bottom surface 6 of the top shell 2 is equal to or greater than the greatest distance of the curved top surface of the top shell 2 from said bottom surface 6. The curved top surface of die top shell 2 is not visible in the figure.

High standards are set for hygiene in the food industry and, for example, in hospitals. In order to be able to meet these standards, the cable clamp must have the fewest possible recesses, nooks and other parts in which bacteria and dirt can be trapped. To that end, the top shell 2 must be provided with a cover for sealing off the abovementioned recesses and nooks. By use of the ridge 11 it is, however, possible to use a simple cover 14, which in particular is of a substantially flat design. The preferred embodiment illustrated in the figure shows a cover 14 provided with a snap-on edge 15, which grips in a sealing manner on the outside side wall of the raised ridge 11. This produces an optimally sealed space on the top side of the top shell 2. When the cover has been fitted, the cable clamp can easily be hosed down to clean it, even by means of a high-pressure jet, Even then, no liquid remains behind in the space bounded by the cover 14 and the ridge 11.

As illustrated in the embodiment of the figure, die outside side wall of the ridge 11 preferably lies flush with the outside of the top shell 2. Tis ensures tat after the cover 14 has been put on, the top shell is virtually completely flat. Only the outside 12 and 13 of the top shell is visible in the drawings.

In the embodiment shown in the figure, the top side of the top shell is provided with interconnected reinforcement ribs which extend vertically from the curved top surface (not visible) of the top shell 2, and only two of which are provided with the reference numerals 16 and 17. The end faces of the reinforcement ribs 16, 17 lie flush with the end face of the raised ridge 11. This means that the reinforcement ribs 1 6, 17 also provide supporting surfaces for the cover 14. Moreover, die reinforcement ribs act as barriers for the spaces bounded by them in the top side of the top shell 2.

The top shell 2 is provided with through holes 18, 19, which extend perpendicularly to the bottom surface 6 of the top shell 2. Said holes 18 and 19 are bounded on the top side of the top shell 2 by vertical tubes 20, 21, the top surface of which lies lower down to the end face of the ridge 11. The distance over which the end faces of the tubes 20 and 21 lie lower down than the end faces of the ridge 11 is preferably equal to or greater an the thickness of fixing bolts to be passed trough the holes 18 and 19, or nuts tat are screwed onto threaded rods (not shown) projecting through the holes 18 and 19, in order to press the shells 1, 2 onto each other and fix them. A free space is therefore obtained for fitting the fixing bolt or nut,

When a cable has to be fixed, the bottom shell 1 is first fixed on a base. For this purpose, threaded rods cam be screwed into the base in a manner not shown, for the purpose of fixing the bottom shell 1 on the base. The threaded rods are fitted at such a distance from each other and at such a position that said rods call pass through holes (not visible in the figure) provided in a through-running manner in the ends of the bottom shell 1 beyond the recess 5. If desired, the bottom shell 1 can first be fixed by tightening two nuts on the threaded rods, which nuts preferably fall into recesses in the top surface 4 of the bottom shell 1. After the cable has been placed in the recess 5 of the bottom shell 1, the top shell 2 is pushed onto the bottom shell 1. If desired, the cover 14 can be snapped onto the top shell 2 over the ridge 11 and screwed down by means of a nut on the threaded rods running through the holes 18 and 19 of the top shell 2 and the holes 22 and 23 of the cover 14.

It is, of course, also possible to fix the top shell 2 on the bottom shell I first, by tightening two nuts on the threaded rods projecting through the holes 18 and 19 of the top shell 2. In the case of the latter method the cover does not need to absorb die great forces required for fixing the cable.

1. Clamp, comprising a bottom shell (1) and a top shell (2), in which shells the sides facing each other (4, 6 respectively) are provided with a recess (5, 7 respectively) for accommodating at least one cable or one pipe, the underside (3) of the bottom shell (1) providing for a flat support surface, and the top shell (2) having a substantially outward curved top surface, characterized in that the top side of the top shell (2) is provided with a flat supporting surface that runs parallel to the support surface (3) of the bottom shell (1).

2. Clamp according to claim 1, characterized in flat the supporting surface of the top shell (2) is formed by a raised ridge (11) running around said shell, the distance of the end face of the ridge (11) from the bottom surface (6) of the top shell (2) being equal to or greater than the greatest distance of the curved top surface of the top shell from said bottom surface (6).

3. Clamp according to claim 2, characterized in that the outside side wall of the ridge (11) lies flush with the outsides (12, 13) of the top shell.

4. Clamp according to claim 2, in which the top side of the top shell (2) is provided with interconnected reinforcement ribs (16, 17) extending vertically from the top surface, the end faces of which reinforcement ribs lie flush with the end face of the raised ridge (11).

5. Clamp according to claim 2, in which on the ends beyond the recess (7) the top shell (2) is provided with a through hole extending perpendicularly to the bottom surface (6) of the top shell (2), for accommodating a threaded rod for fixing nut or bolt shank, and in which the support surface for the fixing nut or bolt head lies lower down than the end face of the ridge (11).

6. Clamp according to claim 2, in which the top shell (2) is provided with a substantially flat cover (14).

7. Clamp according to claim 6, in which the edge of the cover (14) is provided with a snap-on edge (15), which grips in a sealing manner on the outside side wall of the raised ridge (11).
